(19) United States
(12) Patent Application Publication
(10) Pub. No.: US 2024/0292821 A1
(43) Pub. Date: Sep. 5, 2024

(54) LINE CLIP FOR FISHING REEL

(71) Applicant: Pure Fishing, Inc., Spirit Lake, IA (US)

(72) Inventor: Cameron Ivie, Irmo, SC (US)

(21) Appl. No.: 18/591,913

(22) Filed: Feb. 29, 2024

Related U.S. Application Data
(60) Provisional application No. 63/488,073, filed on Mar. 2, 2023.

(51) Int. Cl. A01K 89/01; A01K 89/015; B65H 59/06

(52) U.S. Cl. CPC A01K 89/0111; A01K 89/0192; B65H 59/06; B65H 2701/355

(57) ABSTRACT

The present invention is a fishing reel spool that holds a line in place. The spool includes a spooling portion and a skirt. The spool further includes a slot and a tab for which loose line may be passed through and behind, respectively, so that the line can be held in place. The spool may include a biasing member and may include a secondary member for further holding the line in place and for aiding in inserting the line.

### CROSS-REFERENCE TO RELATED APPLICATIONS

This application claims the benefit of U.S. provisional Patent Application No. 63/488,073 filed Mar. 2, 2023, the entire contents of which is incorporated by reference herein.

### FIELD OF THE INVENTION

The present invention relates generally to a line clip for a fishing reel spool. More particularly, the invention relates to a spool that has a slot and tab integrally formed into the spool body to create a line clip that does not substantially protrude from the outside surface of the spool.

### BACKGROUND OF THE INVENTION

The main function of a line clip is to hold the end of a loose line in place to avoid further unspooling of the line. With many different lines of vastly different thicknesses and stiffnesses, it can be difficult to securely hold both the thinnest and softest line as well as the thickest and stiffest line (i.e., lines with varying memory) with the same line clip. Another difficulty is that for a line clip located on a spinning reel spool, the clip must also keep a low profile relative to the outside surface of the spool to avoid inadvertently catching the line while operating the reel during casting or retrieving. This low-profile requirement can also make it more difficult to insert the line into the line clip. This creates a balancing problem in the design of traditional line clips between easy access and preventing the line from inadvertently catching. Further, because line placed under such traditional line clip designs will cause the clip to move outward, the clip then becomes more likely to inadvertently catch the line again while fishing.

The line clip is also sometimes used to set and hold a casting distance. After line is cast or let out of the spool to a desired distance, the line is then placed into the line clip. The line can be retrieved, and on the next cast the clip will stop the cast at the same distance. In this way, the line and any associated bait on the line can be cast to the same distance repetitively. With many existing line clips designs, if a fish were to take the bait and pull out line against the drag up to the point where the line is held by the line clip, the line can be stopped from letting out entirely by the line clip, possibly causing the line to break.

Thus, a solution is desired wherein a line clip has both a low profile while still being easy to access and wherein the line clip can hold casting distances but does not hold so tightly as to cause the line to break when fish pull out line.

### SUMMARY OF THE INVENTION

The present invention provides a feature that acts as a line clip but that does not substantially protrude from the body of the spool. This feature is rigid with respect to the spool, and in some embodiments may be integrally formed with the spool. An opening is provided in the spool body, thus preferably allowing a part of the line stored on the spool to pass through the opening so as to interface with the inward surface of the feature. A biasing device can be provided which applies a force to the line against the inward surface of the feature, thus further holding the line in place.

### BRIEF DESCRIPTION OF THE DRAWINGS

For a better understanding of the present invention, reference may be made to the following accompanying drawings.

FIG. 1 is a perspective view of a fishing reel spool with an opening slot that acts as a line clip in accordance with an embodiment of the present invention.

FIG. 1A is a perspective view of a fishing reel spool with an opening slot that acts as a line clip in accordance with another embodiment of the present invention.

FIG. 2 is a photographic perspective view showing line spooled and clipped on the fishing reel spool of FIG. 1.

FIG. 3 is a photographic perspective view of a lower interior of the fishing reel spool of FIG. 1.

FIG. 4 is an exploded perspective view showing additional components of the fishing reel spool of FIG. 1.

FIG. 5 is a perspective view of a coil spring biasing member that can be used in one embodiment of the fishing reel spool of FIG. 1.

FIG. 6 is a perspective view of a wavy spring biasing member that can be used in one embodiment of the fishing reel spool of FIG. 1.

FIG. 7A is a side elevation view of the fishing reel spool of FIG. 1.

FIG. 7B is a section view of the fishing reel spool according to FIG. 7A.

FIG. 7C is a section view of the fishing reel spool according to FIG. 7A.

FIG. 7D is a section view of the fishing reel spool according to FIG. 7A.

FIG. 7E is a section view of the fishing reel spool according to FIG. 7D.

### DETAILED DESCRIPTION OF THE INVENTION

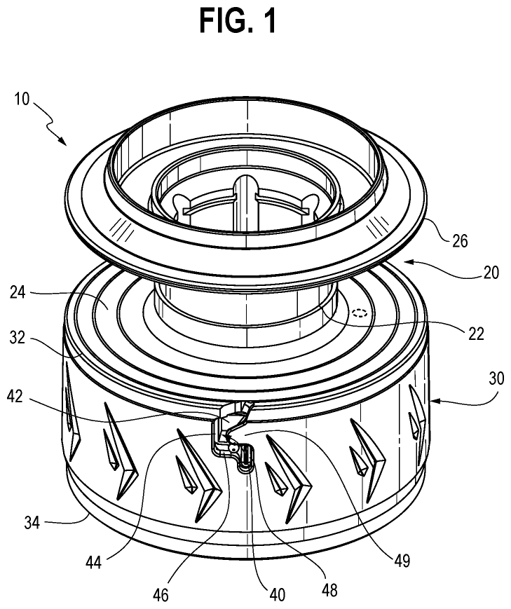

An embodiment of a spool 10 is illustrated in FIG. 1. The spool 10 includes a spooling central portion 20 around which fishing line (not shown in FIG. 1) may be spooled or wrapped. The spooling central portion 20 preferably includes a recessed spooling portion 22 that is a tubular shape. The spooling central portion 20 may also include bottom and top spooling faces 24, 26 that extend outwardly from the bottom and top of the recessed spooling portion 22, respectively, in a plane perpendicular to a central axis of the tube of the recessed spooling portion 22. The bottom and top spooling faces 24, 26 may be substantially circular and preferably have substantially similar diameters.

The spool 10 also includes a spool skirt 30 that is a tubular shape that extends downwardly from an outer diameter of the bottom spooling face 24 and in the opposite direction of the top spooling face 26. The outer diameter of the bottom spooling face 24 joins with the spool skirt 30 to form the spool skirt top 32. An opposite distal end of the spool skirt 30 tube forms the spool skirt bottom 34.

The spool 10 further includes a slot 40 comprising open sections in the spool skirt 30 and the bottom spooling face 24. One embodiment of the slot 40 is shown in FIG. 1 and includes a slot first section 42 that projects substantially radially outwardly. In some embodiments, the first section 42 may be oriented at an angle that is not exactly radially outward along the bottom spooling face 24 to the outer diameter of the bottom spooling face 24 and the spool skirt top 32. The slot first section 42 may also project partially into the spool skirt 30. A slot second section 44 may connect to the slot first section 42 and project through the spool skirt 30 downwardly from the spool skirt top 32 towards the spool skirt bottom 34. A slot third section 46 may connect to a distal end of the slot second section 44 that is opposite the spool skirt top 32 and project substantially in a parallel direction to the spool skirt top 32 and bottom 34 across the spool skirt 30. A slot fourth section 48 may connect to a distal end of the slot third section 46 that is opposite from where the slot second section 44 connects and projects towards the spool skirt bottom 34.

An alternative embodiment of a slot 40a is shown in FIG. 1A and includes a generally U-shaped open section 42a in the spool skirt 30a. In some embodiments, as shown in FIG. 1A, the upper portions of the U-shaped open section 42a of the slot 40a may project partially into the bottom spooling face 24a. In other embodiments, the U-shaped open section 42a of the slot 40a may be located entirely within the spool skirt 30a.

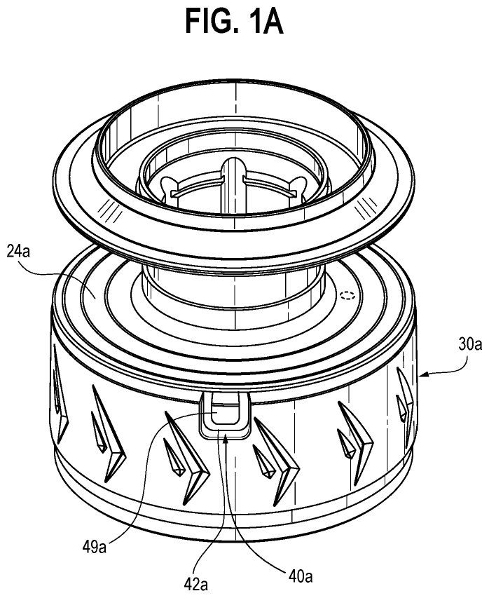

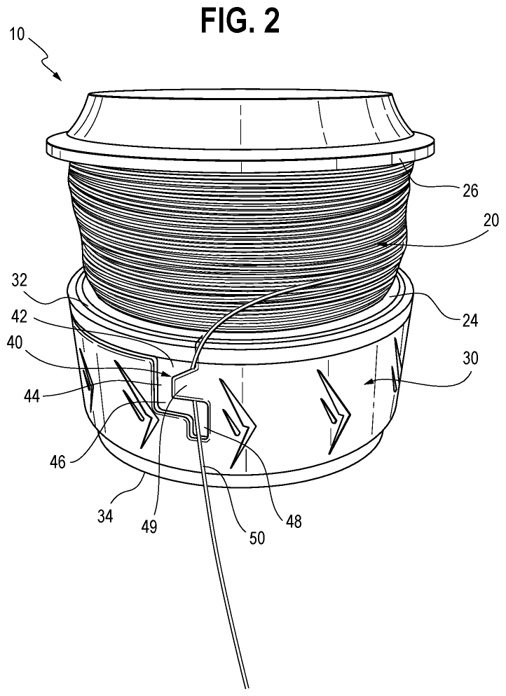

The shape of the slot 40 may define a tab 49 that is part of the spool skirt 30 (see also tab 49a as shown in FIG. 1A). As shown in FIG. 2, string, rope, or line 50 can be spooled around the spooling central portion 20. An excess portion of line 50 that is not spooled may be passed through the slot 40 so that the line 50 passes behind the tab 49 and then passes back through the slot 40. For example, the excess line 50 may first be passed into the slot first section 42, run behind the tab 49, and then passed back out the slot fourth section 48. The line 50 is then engaged with the slot 40 and tab 49 such that line 50 can resist substantial movement and undesirable unspooling of the line 50. Put another way, a portion of the line 50 may be “hooked” or “looped” behind the tab 49 by passing in and out of the slot 40 on either side of the tab 49.

In the configuration shown in FIG. 2, the line 50 resists movement and unspooling primarily through frictional engagement with the slot 40 and tab 49 due to creating “pinch” points in the line 50 as it wraps around the tab 49. However, this frictional engagement can still be overcome if the line 50 is pulled with enough force. While it is desirable for the line 50 to be able to let out slightly in some instances, it may be desirable to require a greater force to do so, especially for lines with low memory. In those instances, a biasing member 60 can be incorporated to increase the amount of frictional engagement force. The biasing member 60 is placed on the interior of the spool skirt 30 and is supported substantially in alignment with the slot 40. The biasing member 60 places force on the line 50 against the tab 49 or other portion of the interior of the spool skirt 30. The biasing member 60 can be varied in material, size, shape, and other means to vary the amount of biasing force applied to the line 50.

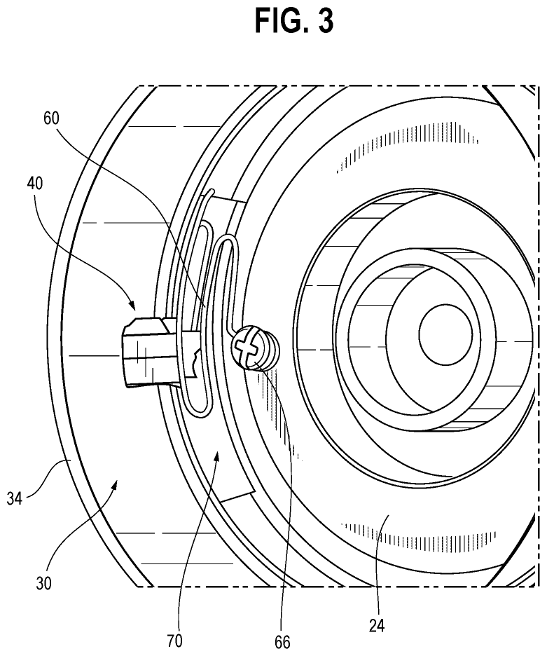

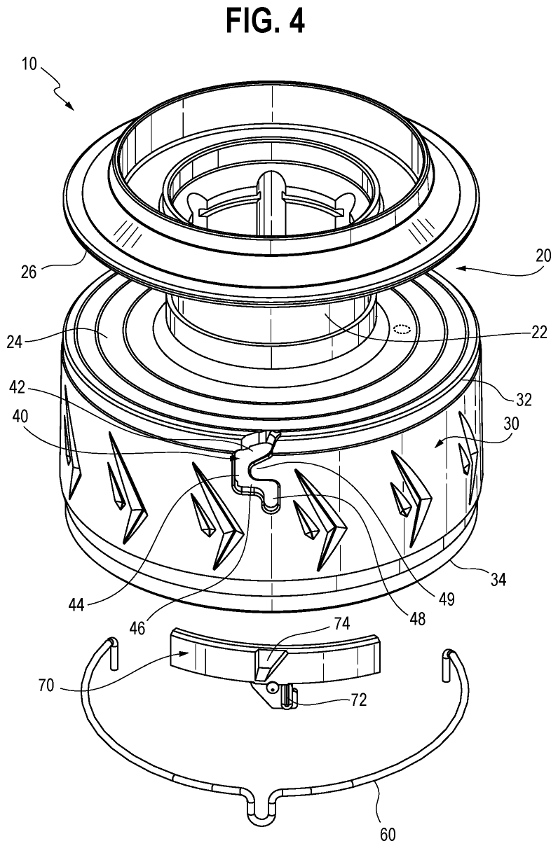

In another embodiment, as shown in FIG. 3, a secondary member 70 may be provided between the biasing member 60 and the interior of the spool skirt 30. As shown in FIG. 4, the secondary member 70 may include an alignment structure 72 that aids in keeping the secondary member 70 aligned with the slot 40. The secondary member 70 may also include a cutout or relief slot 74 that can further aid in keeping the line 50 properly aligned and engaged with the slot 40 during spooling or unspooling of the line 50. The secondary member 70 may also be configured to aid a user in inserting the line 50 into the slot 40 or to further hold the line 50 in the slot 40. The secondary member 70 may further be used for cosmetic purposes.

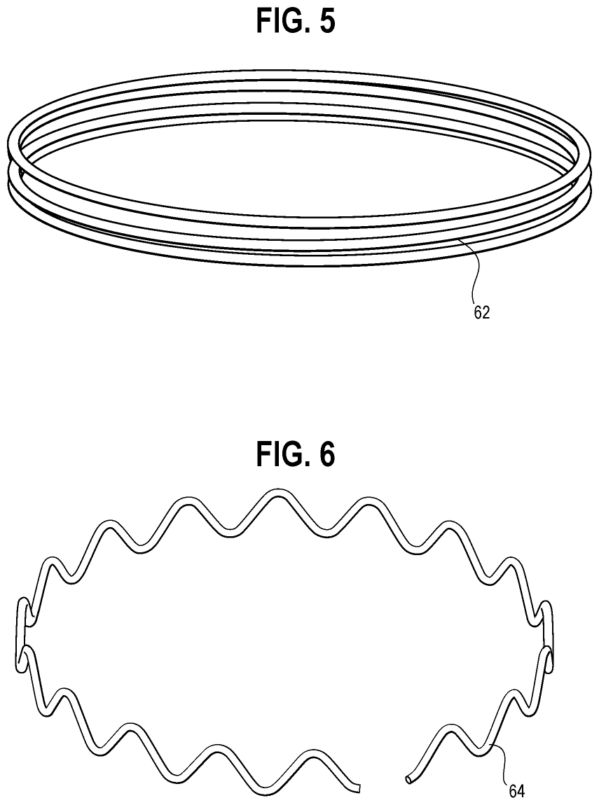

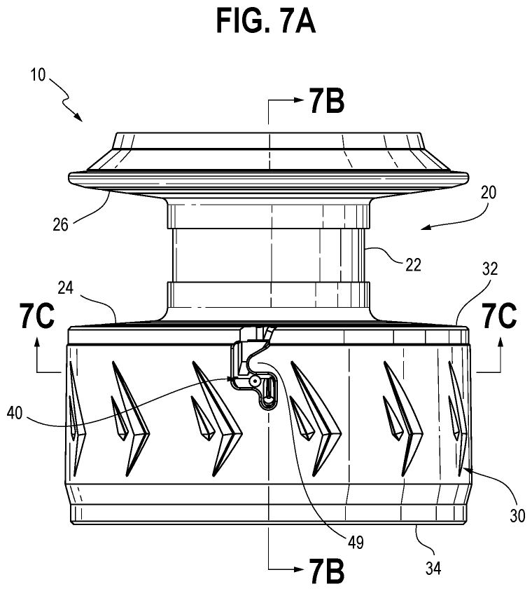

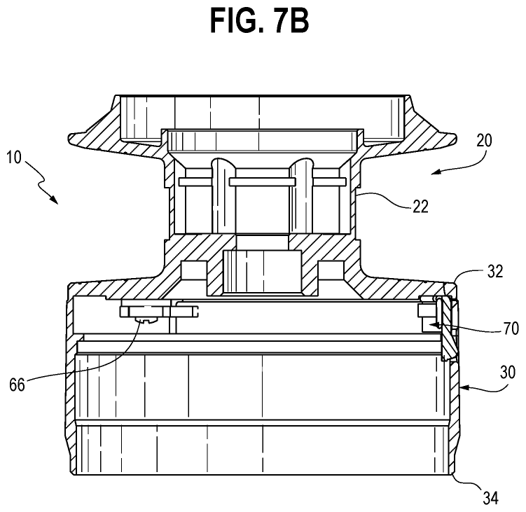

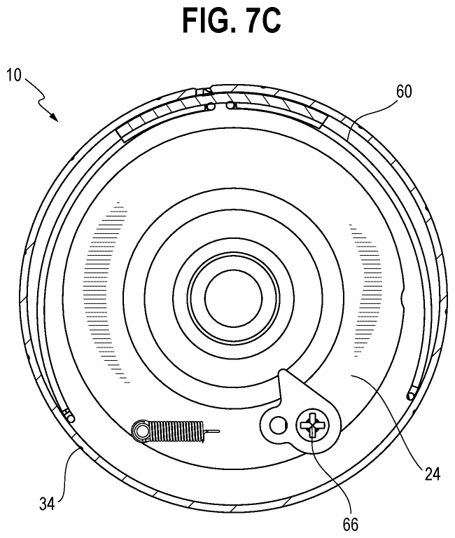

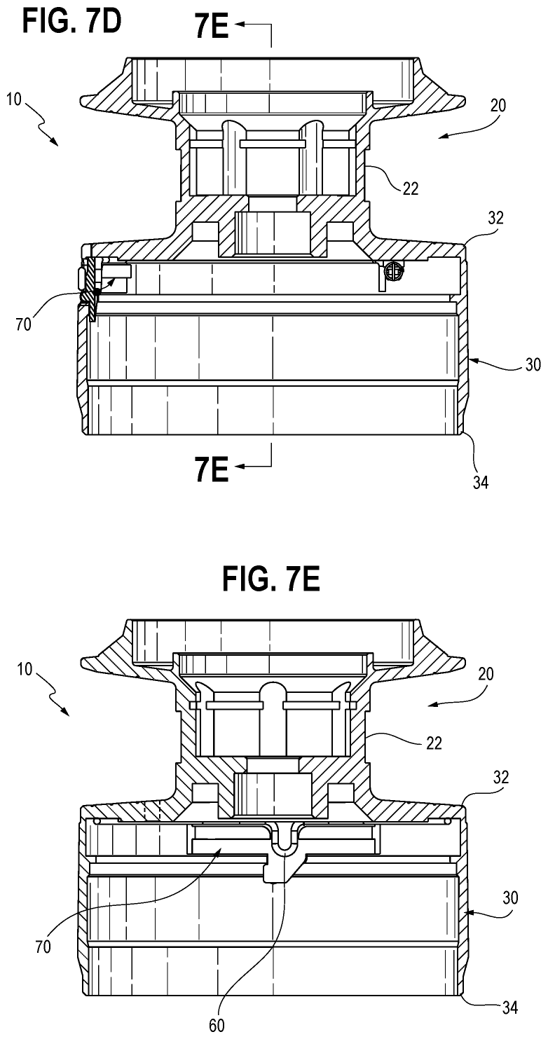

In some embodiments, the biasing member 60 can be a coil spring 62 (as shown in FIG. 5) or a wavy spring 64 (as shown in FIG. 6). In each embodiment the biasing member 60 is supported substantially in alignment with the slot 40 and places a frictional force on the line 50 directly or indirectly, with or without the use of the secondary member 70. In some embodiments, the biasing member 60 may be self-supporting within the interior of the spool skirt 30 by the force of the biasing member 60. In other embodiments, the biasing member 60 may need to be fixed by other means to the spool 10. For example, as shown in FIG. 3, the biasing member 60 can be fixed to the underside of the bottom spooling face 24 or an interior portion of the skirt 30 by a biasing member anchor 66, which can be a screw, pin, or any other device suitably configured for fixing or anchoring the biasing member 60 to the spool 10.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations.

Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present invention.

Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. A fishing reel spool, the spool comprising:
a spooling area for holding a line;
a skirt;
a slot formed as an opening at least partially in the skirt;
a tab defined by the slot; and
a biasing member on an interior portion of the skirt;
wherein the slot is configured such that a portion of the line can be passed into the slot such that a first section of the line is positioned behind the tab and a second section of the line extends back out of the slot; and
wherein the biasing member is capable of biasing the line against the tab.

2. The spool of claim 1, further comprising a secondary member located between the biasing member and the interior portion of the skirt.

3. The spool of claim 2, wherein the secondary member comprises an alignment structure for aligning the secondary member with the slot.

4. The spool of claim 1, wherein the biasing member is a coil spring or a wavy spring having a diameter substantially corresponding to a diameter of the interior portion of the skirt.

5. The spool of claim 1, wherein the interior portion of the skirt includes an anchor for holding the biasing member in a position such that the biasing member engages the line against the tab or interior portion of the skirt.

6. The spool of claim 1, wherein the spooling area includes:
a tubular section around which the line is configured to wrap; and
a face projecting substantially perpendicular to the tubular section;
wherein the skirt extends substantially perpendicular to the face and adjacent an outer edge of the face.

7. The spool of claim 6, wherein the face includes an anchor on a bottom surface of the face opposite a top surface of the face that is adjacent the spooling area, and wherein the anchor can hold the biasing member in a position such that the biasing member engages the line against the tab or the interior portion of the skirt.

8. The spool of claim 6, wherein the slot extends at least partially into the face.

9. The spool of claim 1, wherein the tab does not project beyond an outer surface of the skirt.

10. A fishing reel spool, the spool comprising:
a spooling area for holding a line;
a skirt;
a slot formed as an opening in the skirt; and
a tab defined by the slot;
wherein the slot and the tab are configured to hold a portion of the line such that the portion of the line held by the slot and the tab resists movement unless a sufficient force is applied to the line.

11. The spool of claim 10, further comprising a biasing member capable of providing a force holding the line against an interior surface of the skirt, wherein the force provided by the biasing member increases the amount of sufficient force to overcome movement of the portion of the line held by the slot and tab.

12. The spool of claim 11, further comprising a secondary member located between the biasing member and the inside portion of the skirt.

13. The spool of claim 12, wherein the secondary member comprises an alignment structure for aligning the secondary member with the slot.

14. The spool of claim 12, wherein the slot is a primary slot, and wherein the secondary member includes a secondary slot that aligns with the primary slot.

15. The spool of claim 10, wherein the tab is flush with an exterior surface of the skirt.

16. A fishing reel spool, the spool comprising:
a spooling area for holding a line; and
a skirt, wherein the skirt comprises a slot;
wherein the slot is configured such that a section of the line can be passed into the slot and positioned under an inside portion of the skirt.

17. The spool of claim 16, further comprising a biasing member capable of providing a force holding the line against the inside portion of the skirt.

18. The spool of claim 17, further comprising a secondary member located between the biasing member and the inside portion of the skirt.

19. The spool of claim 18, wherein the secondary member comprises an alignment structure for aligning the secondary member with the slot.

20. The spool of claim 16, wherein the slot includes a first section, a second section, and a third section, and wherein the first section, the second section, and the third section each are adjacent the tab.
